(19) United States
(12) Patent Application Publication
(10) Pub. No.: US 2024/0091814 A1
(43) Pub. Date: Mar. 21, 2024

(54) DYNAMIC PARCEL ALLOCATION AND SORTATION FOR EFFICIENT OUTBOUND OPERATIONS

(71) Applicant: Dexterity, Inc., Redwood City, CA (US)

(72) Inventors: Samir Menon, Atherton, CA (US); Roger Lam Hau, San Carlos, CA (US); Zhouwen Sun, Redwood City, CA (US); Prabhat Kumar Sinha, Santa Clara, CA (US)

(21) Appl. No.: 18/238,322

(22) Filed: Aug. 25, 2023

Related U.S. Application Data
(60) Provisional application No. 63/401,295, filed on Aug. 26, 2022.

(51) Int. Cl. B07C 3/00; B65G 1/137

(52) U.S. Cl. CPC B07C 3/006; B65G 1/1373

(57) ABSTRACT

A robotic sorting system, method, and device is disclosed. The robotic sorting system includes a communication interface, and one or more processors coupled to the communication interface. The one or more processors are configured to (a) obtain item data via the communication interface, the item data including an indication of one or more items to be routed across a plurality of outbound stations, (b) obtain capability data for the plurality of outbound stations, the capability data indicating one or more capabilities for at least one outbound station, (c) determine a plan to route a selected item to a destination outbound station selected from among the plurality of outbound station, the plan being determined based at least in part on the item data and the capability data for the destination outbound station, and (d) cause the plan to be implemented to route the item to a particular handling path associated with the destination outbound station.

### CROSS REFERENCE TO OTHER APPLICATIONS

This application claims priority to U.S. Provisional Patent Application No. 63/401,295 entitled DYNAMIC PARCEL ALLOCATION AND SORTATION FOR EFFICIENT OUTBOUND OPERATIONS filed Aug. 26, 2022 which is incorporated herein by reference for all purposes.

### BACKGROUND OF THE INVENTION

Parcel and other distribution centers may receive an arbitrary mix of items of various sizes, dimensions, shape, weight, rigidity, and/or other attributes, often in a cluttered arbitrary mix. Each item may have machine readable information, such as text and/or optically or otherwise encoded information, which can be machine read and used to route the item, e.g., via an automated sorting/routing system and/or processing. To read the information for a given item, in a typical approach the items are separated from one another via a process known as “singulation.”

Typically, singulation has been performed manually by human workers. A mix of items arrives at a workstation, e.g., via a chute or other conveyance, and each of a set of one or more human workers manually separates items and places them in a defined space for a single item on a conveyor belt or the like. For each item, its destination (or at least next leg of transport) is determined by machine-reading information on the item, and the item is routed to a destination associated with the next leg, such as a bag, bin, container, or other receptacle and/or a delivery vehicle or staging area associated with the next leg.

Manual singulation processes are labor-intensive and can be inefficient. For example, a downstream human worker may have few locations on which to place singulated items, e.g., as a result of upstream workers filling many of the single item spots. Collective throughput may be suboptimal.

Use of robots to perform singulation is challenging due to the arrival of a cluttered mix of items at a workstation, the dynamic flow of items at each station and overall, and the result that it may be difficult to identify, grasp, separate (singulate) items using a robotic arm and end effector in an automated manner, and to adapt to changing states or conditions with respect to the workstation or the items therein.

### BRIEF DESCRIPTION OF THE DRAWINGS

Various embodiments of the invention are disclosed in the following detailed description and the accompanying drawings.

FIG. 1A is a diagram illustrating a robotic routing system according to various embodiments.

FIG. 1B is a diagram illustrating a robotic routing system according to various embodiments.

FIG. 1C is a diagram illustrating a robotic routing system according to various embodiments.

FIG. 2 is a diagram illustrating a robotic routing system according to various embodiments.

FIG. 3 is a diagram illustrating a system for routing a plurality of items across a plurality of outbound stations according to various embodiments.

FIG. 4 is a diagram illustrating a system for routing a plurality of items across a plurality of outbound stations according to various embodiments.

FIG. 5 is a diagram illustrating a system for routing a plurality of items across a plurality of outbound stations according to various embodiments.

FIG. 6 is a diagram illustrating a system for routing a plurality of items across a plurality of outbound stations according to various embodiments.

FIG. 7 illustrates a method for routing an item to an outbound station according to according to various embodiments.

FIG. 8 illustrates a method for routing a plurality of items across a plurality of outbound stations according to according to various embodiments.

FIG. 9 illustrates a method for routing a plurality of items across a plurality of outbound stations according to according to various embodiments.

FIG. 10 illustrates a method for obtaining a plan for routing a plurality of items to one or more outbound stations according to according to various embodiments.

FIG. 11 illustrates a method for routing a plurality of items across a plurality of outbound stations according to according to various embodiments.

FIG. 12 illustrates a method for routing an item to an outbound station according to according to various embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

As used herein, a worker may include a human operator, a robotic system configured to perform one or more tasks, etc.

As used herein, an outbound station may correspond to a workstation at which a worker receives items (e.g., from a sortation network) and places the items at a destination location, such as a pallet, a shipping container, a truck, etc. The outbound station may include one or more workers to pick and place the items being received.

Techniques are disclosed to programmatically analyze the types of parcels (e.g., packages, bags, boxes, other items, etc.) flowing through a sortation network and determine the best way to route the parcels to end-points so the parcels can be dispatched to outbound processes.

Parcels/items may arrive, via truck, container, or other conveyance, and may be placed into a sortation network. The sortation network may comprise humans or robots that operate to place the item singly (e.g., to singulate) on a segmented conveyor. Image sensors may be used to route each parcel to an endpoint associated with a further destination, such as a “door” or loading/packing area where parcels/items destined for a same downstream location may be packed/loaded, such as onto a pallet, into a box, or onto a truck or shipping container or other freight carrier, etc.

In related art systems, items may generally be sent to a door/destination as they are encountered. However, the workers at each door may have different states, capabilities, etc., and may need to pack items in a certain order to achieve a certain stability, an efficient use of space, and to avoid item damage, etc. As an example, different numbers of human workers with different limitations and abilities may be deployed at a door. As another example, one or more robots having different end effectors, geometries, etc. may be deployed.

According to various embodiments, a system is configured to programmatically route parcels/items based at least in part on predefined considerations. The predefined considerations may include the state of the workspace at an outbound station, a set of workers at an outbound station, a manifest or order assigned to an outbound station, etc. Various other considerations as disclosed herein may be implemented.

In various embodiments, the system uses a sensor system (e.g., one or more sensors) and other feedback to track a worker state (e.g., a robot state or a human operator state, etc.) and needs, and determines/controls for one or more of item destination, delivery order, delivery speed, delivery time, etc. to ensure efficient operations. The system controls the routing/delivery of items across one or more outbound stations to maximize throughput. As an example, the system optimizes for a value function that is subject to one or more constraints such as stability of the stack of items, weight balancing of the stack of items, outbound station capabilities, state of the outbound station workspace (e.g., the state for a current stack of items), etc.

In various embodiments, the items may be routed based on one or more of (i) a set of predefined categories based on a predefined specification(s), (ii) dynamically computed categories, (iii) a specific item-by-item basis based on item characteristics, (iv) a specific item-by-item basis based at least in part on the operation conditions of the sorter (e.g., a robotic sortation system). In some embodiments, the set of predefined categories, or dynamically computed categories may be defined include (a) items based on an item assignment to a particular outbound station or set of outbound stations (e.g., a set of outbound stations assigned to a particular end destination, order, or customer), (b) items based on shape or manipulability (e.g., some outbound stations may have robotic arms that are configured with grippers that are ideal for grasping boxes, and other outbound stations may have robotic arms that are configured with claws that are more suited for grasping irregular objects), (c) the task to be performed with respect to the item (e.g., unpacking to obtain a set of objects, packing/kitting into a larger package, such a palletization of the item, etc.), (d) time within which the item has to be handled (e.g., such as to be handled by the outbound station, or to be delivered to the particular end destination). Certain categories may be assigned to a certain outbound station(s) and the system routes items corresponding to a category to the outbound station to which the category is assigned.

The techniques disclosed herein to route items to one or more outbound stations may be performed in two stages: (a) a configuration or specification step at which a high-level behavior is defined and is typically related to physical feasibility of a sort plan at the system level, and (b) a performance step (e.g., real-time operation of the robotic sortation system) based on sorting conditions or conditions/states of an outbound station(s). Each stage may have metrics and conditions that define behavior (e.g., that are used to determine the sorting, routing, singulation and/or packing of the items. The system uses an overall value function to guide the optimization of the metrics and/or conditions.

Related art systems do not implement dynamic sorting strategies, such as strategies geared to simplify and optimize end-point dispatch out of a warehouse. Various embodiments use dynamic sorting strategies that dynamically sort/route items across one or more outbound stations while considering trailer loading and/or pre-dispatch palletizing with workers.

According to various embodiments, a system, method, and robotic structure for routing items is provided. The method includes (a) receiving sensor data via the communication interface, the sensor data including data associated with an item present in a workspace for a robotic structure configured to route the item, and (b) using the sensor data to determine and implement a plan to autonomously operate the robotic structure to route the item to a particular handling path based at least in part on the sensor data and one or more capabilities associated with an outbound station for the particular handling path.

According to various embodiments, a system, method, and robotic structure for routing items is provided. The method includes (a) obtaining item data via the communication interface, the item data including an indication of one or more items to be routed across a plurality of outbound stations, (b) obtaining capability data for the plurality of outbound stations, the capability data indicating one or more capabilities or states for at least one outbound station, (c) determining a plan to route a selected item to a destination outbound station selected from among the plurality of outbound station, the plan being determined based at least in part on the item data and the capability data for the destination outbound station, and (d) causing the plan to be implemented to route the item to a particular handling path associated with the destination outbound station.

The system is configured to dynamically sort/route items (or determine a dynamic sortation/routing of the items) for a plurality of types of items. Various items that system may handle include boxes, parcels, polybags, cases of sub items (e.g., cases of juice, trays of bread, etc.), eaches, etc. Additionally, or alternatively, the system may implement the sorting/routing for a various types of outbound activities (e.g., at the outbound stations), such as truck loading, palletizing, case packing, kitting, etc. Additionally, or alternatively, the system may implement the sorting/routing of the items for various types of modalities, such as a set of one or more robots, a group of a robot(s) and human worker, a group of one or more human workers. In some embodiments, the system is implemented to route/sort items according to one or more of (a) various types of items, (b) various types of outbound activities, and/or (c) various types of modalities. For example, the system is configured to route boxes across six different outbound stations in parallel. The techniques according to various embodiments are used to decide for an item (e.g., on an item-by-item basis) a particular outbound station to which the item is to be routed, an ordering in which the item is to be delivered, a timing for delivery of the item, etc. Outbound stations may include, for example, one robot truck-floor loader, two robot palletizers, one human palletizer, two human truck loaders.

Related art systems sub-optimally route and pack items. The system according to various embodiments improves on the related art systems by using dynamic routing/sorting techniques disclosed herein to efficiently route/sort and pack items. According to related art systems, it was infeasible to determine how to route items to dispatch zones (e.g., zones at which an outbound stations loads the items to a freight carrier, etc.) in a manner that optimizes the utilization of manual labor and robots at the dispatch zones. Thus, related art systems led to a loss in efficiency because humans and robots work in different ways and sending human-relevant work to robots (or vice versa) reduces the system efficiency. In contrast, the system according to various embodiments dynamically determines a sorting/routing of items to corresponding dispatch zone in a manner that optimizes a value function, subject to one or more constraints such as (i) a stability constraint, (ii) an order, manifest, or destination associated with an outbound station, (iii) available space in the freight carrier, pallet, etc., (iv) workstation capabilities, etc. Various other constraints may be implemented. The optimization may be in accordance with the predefined value function.

Ensuring that robots operate productively (e.g., robots that are optimized for productivity) is very difficult in related art systems involving complex logistics or sorting warehouses. For example, related art systems had no clear idea on how to design sortation systems to optimize human-robot collaboration. These deficiencies of related art systems led to either singular focus robot-enabled or human-only warehouse designs that are worse than a joint optimized warehouse. The dynamic sortation system according to various embodiments enables efficient utilization of human labor by routing different types of packages to people with different physical capabilities or assigned different tasks.

In various embodiments, the system routes (e.g., determines to route and/or a plan for routing) an item based at least in part on one or more of (a) a predefined item specification (e.g., an indication that a particular item, type of item, or item having a particular characteristics is to be handled by a first robot, or an indication that the item is to be handled by a human worker), (b) robot fill rate (e.g., throughput) estimates (e.g., to send robots items it handles most quickly), (c) a model for one or more of a statistical producer (e.g., sort system) and outbound station (e.g., the robot loading a truck with arriving items), (d) item statistics-oriented robot behavior modifications, (e) different capability robots. As an example of the item statistics-oriented robot behavior modifications, the robotic sortation system may determine that a set of identical items are to be sorted/routed (e.g., a box full of identical boxes arrives to the warehouse), the robotic sortation system may perform a query with respect to various outbound stations (e.g., the system may indicate to a robot(s) that a set of items of a particular size, type, etc. are to be handled), the robotic sortation may determine that a particular outbound station has a robot with an upgraded or higher picks per hour (PPH) (e.g., the particular robot may respond to the system of its upgraded PPH capability), and the robotic sortation system routes the set of items accordingly (e.g., the robotic sortation system sends more of the items to the robot with upgraded PPH capability). As an example of robots having different capabilities, a first outbound station may comprise one or more lightweight robots to handle smaller but faster moving items (e.g., items being delivered to the outbound station at relatively higher rates), and a second outbound station may comprise one or more heavier/stronger robots to handle relatively larger/heavier items.

In some embodiments, the system the system determines routing decisions (e.g., whether to deliver to a robot, a particular type of robot, a human worker, etc.) and speed may be based on based at least in part on item shape and worker gripper capabilities.

In some embodiments, the system optimizes the inflow of items (e.g., routing and delivery of items to an outbound station) based at least in part on item sizes, item types, etc. As an illustrative example, rather than stick a set of small items that may fall down beyond a certain height (e.g., multiple 8 in.×8 in.×1 in. boxes), a combination of desired different stack-friendly dimension boxes (e.g., boxes having dimensions of 24 in.×24 in.×24 in.) is sent to the outbound station (e.g., the robot/human workers) in a given order that results in a desired stability to the stacked tower of items. As another illustrative example, if a given input comprises a set of boxes and plastic packages (or another package that cannot be stacked with desired stability), then the system sequences the input items so that a stack of the items reaches a predefined height with desired boxes and thereafter the plastic packages are provided (or other packages that cannot be stacked with a desired stability/minimum stability threshold) can be put on the top of the stack. The system may repeat the foregoing sequence for each tower/stack of items.

In some embodiments, the system makes dynamic decisions for routing/delivering items to outbound stations based on an inflow of packages to maximize stack stability and packaging density. The dynamic decisions may be further constrained based on weight balancing, end destination or order/manifest associated with the item, etc. In response to the system determining (e.g., by actual data or extrapolated based on prior data) that a particular route has a certain percentage of stack-friendly items (e.g., boxes) and a certain percentage of non-stack-friendly items (e.g., carpets), then the decision algorithm determines to leave appropriate spaces (e.g., in the container) to put non-stack-friendly items at a top of side of the stack. As an illustrative example, if a given route for a truck has five thousand boxes and fifty carpet rolls, then the system dynamically determines to send one thousand packages for a stack to be generated at the workspace of the outbound station (e.g., the shipping container) and then causes ten carpets to be delivered to the outbound station for the worker to put on a top or at a side of the stack of items. The system repeats the foregoing sequence to obtain an optimized stack stability and packaging density across all the items. Locally, the worker (e.g., the robotic system) at the outbound station to implement a stacking of items or loading of the container, etc., may determine the stacking/loading state (e.g., models the stacking/loading of the items) and communicates to the upstream controller/scheduler (e.g., the robotic sortation system) of needs and opportunities (e.g., for smaller or lighter items to be stacked on heavier items that have already been stacked/loaded) or for items of specific dimensions or ranges of dimension to fit into spaces at the top of items that have already been stacked or loaded into the truck or shipping container. The local system (e.g., robots or control system) at outbound stations may locally generate models or states of the workspace or stack/loading of items and provide the model or state to a robotic sortation system to determine a routing/delivery of items across a plurality of outbound stations.

In some embodiments, the system (e.g., a robotic sortation system) routes/re-routes items to a variety of locations (e.g., outbound stations), such as to optimize by sending another item first. As an example, the system may route the item to a local buffer at the outbound station, a local buffer at the workspace of the robotic sortation system. As another example, the system may recirculate items to allow subsequent items to be delivered to the outbound station first and then route the recirculated items. As another example, the system routes the items to another door or outbound station. As another example, the system routes the items to a secondary storage or sortation zone/system.

In some embodiments, the system uses a predefined value function in connection with dynamically determining a routing and/or delivery of items across one or more outbound stations. For example, the system uses a dynamic load balancing algorithm to provide an estimate of the operating cost of handling work (e.g., peak work). The system may use the value function or dynamic load balancing algorithm to enable dynamic pricing.

In some embodiments, the system uses the predefined value function in connection with implementing/providing just-in-time routing. For example, the system controls the timing for delivery of items to a particular outbound station, etc. The algorithm for providing the dynamic/real-time determining the routing of items enables a system to request or deny specific items to be routed to the worker at the outbound station. For example, the system determines (e.g., based on a model or state reported by the control system at the outbound station) that the stacking or packing is midway through packing a wall in a truck and does not need any further large heavy items or that a set of smaller/lighter items should be delivered next. As another example, the system may determine to provide to the worker at the outbound station an item of a particular or having a particular item characteristics (e.g., rigidity, non-fragile, etc.). The local system at the outbound station may request from the robotic sortation system the particular item or item having a particular item characteristic. Alternatively, the robotic sortation system may determine to route/deliver the particular item or item having a particular item characteristic based on the state of the outbound station workspace (e.g., a model or state reported to the robotic sortation system from the control system at the outbound station).

The robotic sortation system may control delivery of items to an outbound station(s), such as by an automated guided vehicle (AGV), a chute, a conveyor, a human operator, etc. The system may control the delivery of items to better enable throughput of the robots. In some embodiments, the system balances the stacking/loading of items across a plurality of outbound stations to optimize the value function associated with stacking/loading items at the plurality of outbound stations (e.g., the system attempts to optimize the stacking/loading in the aggregate across the plurality of outbound stations, such as rather than merely optimizing the stacking/loading at one particular outbound station).

The items may be load balanced across a plurality of outbound stations or a plurality of robots. The system may load balance the routing/delivery of items based on one or more of (a) a current worker load (e.g., stop/pause delivering items to workers that have a lot of backpressure or a large queue of items to be stacked/loaded), (b) an actual or expected worker or outbound station throughput (e.g., the system delivers more items to known throughput robots), (c) a derating of a worker such as a robot derated (e.g., a derating arising from temperature, a hardware failure such as a suction cup on the end effector being damaged, etc.) and the system determines to deliver less item load (e.g., reduces or pauses delivery of items) to the derated worker.

In some embodiments, the system load balances the routing/delivery of items to outbound stations based on a human-centric load balancing. For example, the system can load balance non-human-ergonomic items to robots to allow human workers to have a better work environment (e.g., to induce less strain on the human workers, etc.). As another example, the system can load balance items that robots are ill-equipped to handle (e.g., items that only human workers can operate) to route/deliver items to human workers. As another example, the system can deliver a sequence of items to human workers that best suit a human pattern of loading, delivery, fulfilling, etc. Human workers and robot workers have different capabilities. The system may use historical information to identify types of items that are better suited to robot workers or human workers. For example, the system identifies a throughput for a human worker or robot worker for a particular item (e.g., the system may determine an expected throughput, efficiency, or expected time for stacking/loading items).

In some embodiments, the system selects a destination outbound station to which to route an item based on a shape or manipulability of the item. For example, the system determines a capability of various outbound stations, and selects the destination outbound station to an outbound station having a capability best suited to handle the item. A first outbound station may comprise a robotic arm having a gripper that is best suited for boxes and not well suited for irregularly shaped objects. A second outbound station may comprise a robotic arm having a claw that is better suited to handle the irregularly shaped object but may not be as quick at handling boxes. Accordingly, the system determines an item shape (e.g., based on sensor data) and selects the destination outbound station based at least in part on the item shape and the outbound station best matched to handle the item shape.

In some embodiments, the system selects a destination outbound station to which to route an item based on an availability of the outbound station. The availability may be based on the load of the outbound station or an availability of space left in the truck or container being loaded at the outbound station. The load of the outbound station may be determined based on an item buffer at the outbound station. For example, if one outbound station is buffered up (e.g., has a buffer having a number of items greater than a threshold number of items, or an expected completion time exceeding a predetermined time threshold), the system may determine to route a next item to a different outbound station, such as an outbound station that is not so loaded.

In some embodiments, the system determines an activity/task to be performed with respect to the item and selects a destination outbound station based at least in part on the activity/task to be performed. For example, the system determines whether the item is to be aggregated or broken apart, and determines to route to an outbound station at which the particular task is being performed. For example, the system have an input flow of items of various types, shapes, etc. (e.g., lipstick boxes, boxes of shoes, teddy bears, etc.). The system may determine that smaller items (e.g., smaller than a predetermined size) or items of a particular type/category are to be packaged together or broken apart, and then the system appropriately routes the item to an outbound station. As an example, the system may route large boxes to an outbound station that is configured to unpack the large box and load the smaller items within the large box. As another example, the system may route large boxes to be palletized.

In some embodiments, the system determines a destination outbound station based on when the item needs to be handled. For example, the system determines if the item is being sent to a warehouse, or whether the item is needed immediately (e.g., being sent to an end destination within a threshold period of time, or being sent to a non-warehouse destination). In response to determining that the end destination for the item is a warehouse, then the system may determine to route the item to an outbound station at which items are palletized, or to an outbound station loading a truck or container that is expected to depart at a time greater than a predetermined threshold.

In some embodiments, outbound stations comprise a local controller/control system that determines an item or type of item to be requested from the routing/sortation system routing items. The outbound station control system may send a request for a particular type of item. For example, if the truck or container being loaded at an outbound station is loaded more than a threshold extent (e.g., a threshold height of the stack of items is exceeded), the outbound station control system sends a request to the routing/sortation system for a set of smaller items (e.g., items having a size less than a predefined size threshold). As another example, if the truck or container being loaded is loaded less than a threshold extent, the outbound station control system sends a request for larger items (e.g., the outbound station plans to place larger items towards the bottom of the truck or container.

In some embodiments, the system models the placing a set of items. In some implementations, a local control system at the outbound station generates the model and sends the model or a request for a particular item/type of item to a control system that is configured to control a routing/sortation system. In some implementations, the system comprises a global controller that models the placing the set of items or determines the routing of items (e.g., rather than receiving requests from outbound station) or otherwise determines the items/types of items to be routed.

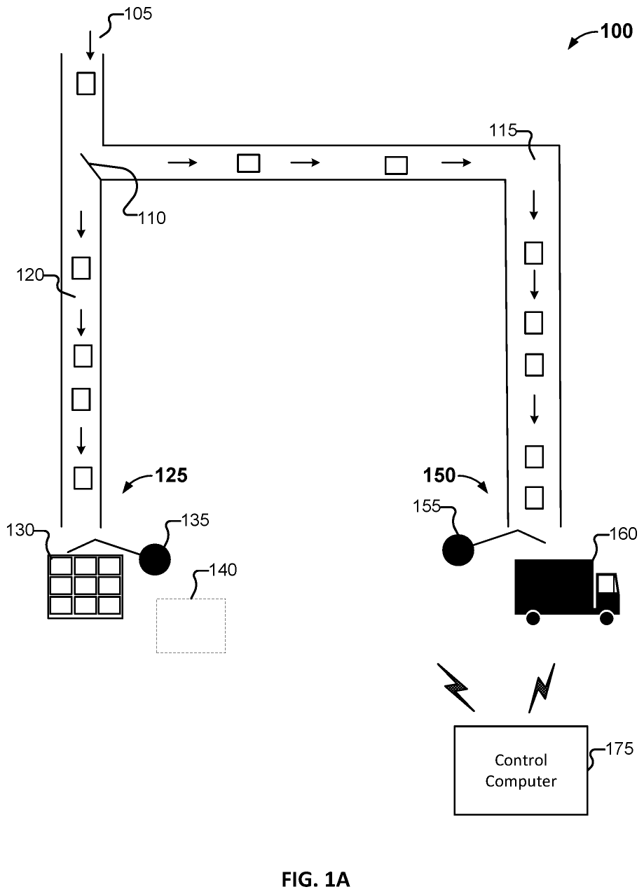

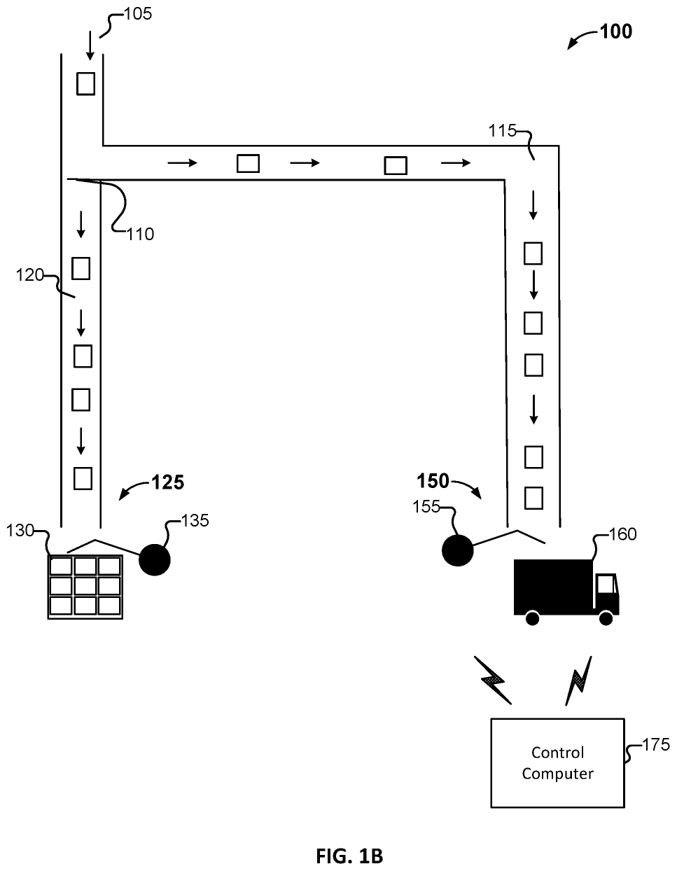

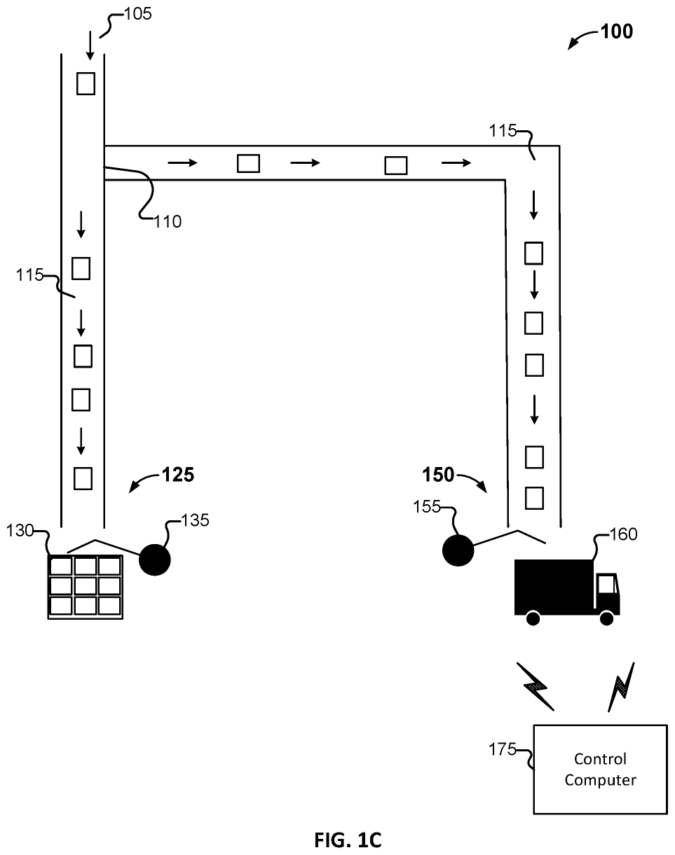

FIGS. 1A-1C is a diagram illustrating a robotic routing system according to various embodiments. In the example shown in FIGS. 1A-1C, system 100 routes/delivers items to various outbound stations, such as outbound station 126 or outbound station 150. System 100 comprises control computer 175 (e.g., a control system) that is configured to dynamically determine a routing/delivery of items across the various outbound stations. In some embodiments, each outbound station comprises a control computer that performs local control of the workers (e.g., robot workers), such as to determine an item to pick and place, and a destination location at which the item is to be placed (e.g., in connection with stacking or loading items such as in a shipping container).

In some embodiments, control computer 175 dynamically determines a routing/delivery of items across outbound stations 125, 150 based at least in part on a state of one or more of outbound stations 125, 150. For example, control computer 175 obtains a model of the workspace for the outbound station and determines a routing/delivery based on the model. As another example, control computer 175 determines a state of a stack of items or a loading of items into a truck or other container and uses the state of the stack of items or the loading to determine whether to route another/next item to the corresponding outbound station or a timing with which the item is to be delivered to the outbound station. Control computer 175 may additionally determine a specific placement of the item by a worker(s) in the destination outbound station. Alternatively, a local control system associated with the outbound station (e.g., a local computer system that controls a robot(s) in the outbound station) may determine a plan for placing the item, including selecting a destination location, and then causing the worker(s) to implement the plan to place the item.

As illustrated, system 100 comprises input zone 105 at which an inflow of items is introduced to system 100 (e.g., to the robotic sortation/routing system). The inflow of items may be carried via a chute or conveyor. As an example, the inflow of items may be loaded from a truck that arrived at the warehouse. System 100 further comprises conveyance structures 115, 120 which respectively correspond to different paths in the sortation network. Conveyance structure 115 carries items from the inflow zone to outbound station 150. Similarly, conveyance structure 120 carries items from the inflow zone to outbound station 125. Conveyance structures 115, 120 may be a conveyor, such as a segmented conveyor, or other means to carry items. In some embodiments, the conveyance structures are controlled by control computer 175. For example, control computer 175 can control a speed at which the conveyance structure carries the item. Control computer 175 may control the speed by controlling a motor that drives the conveyance structure. Control computer 175 can thus control the timing for delivery of a particular item(s) to the corresponding outbound station.

System 100 comprises one or more routing modules, such as routing module 110, to control the routing of items within the sortation network. In the example shown, the configuration or orientation of routing module 110 can be controlled to divert an item along a first path defined by conveyance structure 115 to outbound station 150 or a second path defined by conveyance structure 120. Although FIGS. 1A-1C illustrate that routing module 110 is a baffle or other mechanical structure that is re-oriented to divert items along an appropriate path, various other mechanisms may be implemented to direct an item along the first path or the second path. For example, the routing module may be a multi-directional conveyor comprising different conveyors that can be driven in different directions (e.g., one set of conveyors directing the items along conveyance structure 115 and another set of conveyors directing the items along conveyance structure 120). FIG. 1A illustrates routing module 110 being configured/oriented in an intermediate state between a first state in which the routing module 110 diverts items along the first path, and a second state in which the routing module 110 diverts items along the second path. FIG. 1B illustrates routing module 110 being configured in the first state in which routing module 110 directs/diverts items to the first path defined by conveyance structure 115. As shown, in the first state, routing module 110 restricts/prevents items from flowing to the second path defined by conveyance structure 120. Conversely, FIG. 1C illustrates routing module 110 being configured in a second state in which routing module 110 directs/diverts items to the first path defined by conveyance structure 120. Although FIGS. 1A-1C illustrate system 100 comprising a single routing module 110, in various embodiments, the robotic sortation system (or robotic routing system) may comprise a plurality of routing modules 110.

In response to determining a destination outbound station to which one or more items are to be routed, control computer 175 determines a plan for routing the item(s) to the destination outbound station. For example, control computer 175 determines routing modules that are to be controlled to carry the item along the predefined path to the destination outbound module. In response to determining the routing modules that are to be controlled, control computer 175 determines a manner in which the routing modules are to be controlled. For example, in the case of system 100, control computer 175 determines a manner in which routing module 110 is to be controlled, such as to actuate routing module 110 to be configured/oriented in a first state or a second state, etc. In some embodiments, the plan for routing the item(s) to the destination outbound station includes determining a manner for controlling the conveyance structure(s). For example, control computer 175 determines an expected timing for delivering the item to the destination outbound station and determines how to control the conveyance structures to deliver the item in accordance with the expected timing.

In the example shown, control computer 175 determines to deliver an item to outbound station 150. Control computer 175 determines a time at which the item is to arrive at outbound station 150, such as based on a state of the workspace at the destination outbound station (e.g., a model or state of the stack/loading of items, a state of the worker(s) at the destination outbound station, etc.). Control computer 175 then determines a manner according to which conveyance structure 115 is to be driven to deliver the item to outbound station 150.

In some embodiments, system 100 (e.g., control computer 175) determines a routing or plan for delivering an item to a selected destination outbound station based at least in part on a state or capability of worker(s) within the various outbound stations. System 100 may store a mapping of workers to capabilities. Examples of capabilities include a maximum weight that can be lifted by the worker, a type of end effector, an indication of whether the worker is a robot worker or a human worker, a maximum speed at which the worker can handle items or a particular item/type of item, availability of a buffer zone (e.g., buffer zone 140) in which the worker can buffer items such as to reorder the placement/stacking/loading of items, an indication of a type of robot worker, a range in which the worker can operate (e.g., an indication that the robot is mobile, defined by a linear rail, etc.). Various other capabilities may be implemented. In some embodiments, system 100 uses the capabilities associated with the outbound stations (e.g., the collective capabilities of the workers in the outbound station) as constraints for the decision algorithm for determining how to route items or for the predefined value function used to optimize the stacking/loading of items (e.g., optimized for a particular dimension(s) according to the particular value function). Examples of dimensions for which the value function may be configured to optimize stacking/loading of items includes: (i) stack/loading stability, (ii) stack/loading weight balancing, (iii) throughput of items (e.g., total speed to stack/load all items), (iv) space optimization (e.g., to tightly pack items), etc. The value function may be optimized for various other dimensions.

In some embodiments, system 100 (e.g., control computer 175) determines a routing or plan for delivering an item to a selected destination outbound station based at least in part on an item handling activity. In the example shown, the item handling activity performed at outbound station 125 includes a palletizing items on pallet 130, which may then be loaded into a truck, etc. Robot 135 may be controlled to pick items from conveyance structure 120 when the item arrives at outbound station 125 and stacks the item on pallet 130. As another example, the item handling activity performed at outbound station 150 includes a loading of items to truck 160 or other shipping container. Robot 155 may be controlled to pick items from conveyance structure 115 when the item arrives at outbound station 150 and loads the item directly to truck 160.

In some embodiments, system 100 (e.g., control computer 175) determines a routing or plan for delivering an item to a selected destination outbound station based at least in part on an outbound station modality, such as a single robot worker, a pair of robot workers, a set of different types of robot workers, a set of one or more human workers, a set of robot workers and human workers, etc. In the example shown, both outbound station 125 and outbound station 150 have the same modality—a single robot (e.g., robot 135 and robot 155).

In some embodiments, system 100 (e.g., control computer 175) determines a routing or plan for delivering an item to a selected destination outbound station based at least in part an order or manifest associated with an outbound station (e.g., a manifest or order for which items are being packed), an end destination to which the stack/loading of items are to be delivered, a customer to which the stack/loading of items are to be delivered, etc. For example, outbound station 125 may be associated with a loading of item to be delivered to New York City and outbound station 150 may be associated with a loading of items to be delivered to Chicago. In response to determining that an item entering robotic sortation system at input zone 105 is to be delivered to New York City, system 100 determines to route the item to outbound station 125.

In some embodiments, system 100 (e.g., control computer 175) determines a routing or plan for delivering an item to a selected destination outbound station based on a particular type of item associated with the destination outbound station. For example, if the inflow of items comprises a mix of cereal boxes or bread loves. Outbound station 150 may be assigned a loading of bread loaves and outbound station 125 may be assigned a loading/stacking of cereal boxes. In response to the robotic sortation system receiving a cereal box in the item inflow, control computer 175 determines to route the cereal box to outbound station 125.

The decision algorithm implemented to determine a routing/delivery of items may include determining the routing based on a set of predefined heuristics For example, in the event that outbound station 150 is loading a truck for delivery to a particular end destination, control computer 175 may use a heuristics that larger/heavier items are to be routed to outbound station 150 when the state of outbound station is the truck/container being partially loaded (e.g., at the beginning of the loading). Another heuristic may be to route items that are not conducive to a good stability of a stack/load items toward the end of the loading or after the stack of items has satisfied a predefined minimum height threshold. Another heuristic may be to route to awkward shaped items (e.g., round items, non-rigid items, deformable or rigid items, etc.) to outbound stations comprising human workers (e.g., human workers may be better suited to handle such items). The system may store a set of heuristics respectively associated with item characteristics (e.g., size, weight, shape, etc.). In some embodiments, the system implements a finer algorithm for determining placing of items arriving at outbound stations. For example, the robotic sortation system implements a coarse model for routing items (e.g., a set of heuristics to determine a routing) and the outbound station system (e.g., a local control system) implements a specific placement algorithm that models stability, space utilization, placement speed, weight balancing, etc.

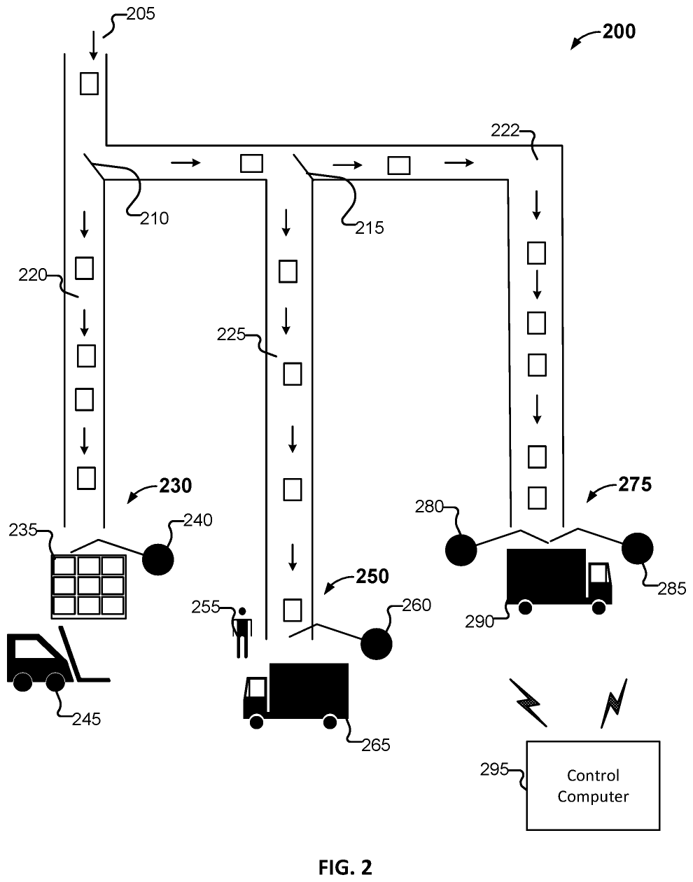

FIG. 2 is a diagram illustrating a robotic routing system according to various embodiments. In the example shown, system 200 comprises a plurality of outbound stations 230, 250, and 275 and a plurality of routing modules 210, 215. In response to determining a destination outbound station to which an inflow item input at input zone 205, control computer 295 determines the routing modules to be controlled and/or the configurations/orientations of the routing modules. As an example, in response to determining to route an item to outbound station 275, control computer 295 controls routing modules 210, 215 to be configured in a first state, such as so routing module 210 restricts the flow of items to outbound station 230 and routing module 215 restricts the flow of items to outbound station 250. Control computer 295 may determine a plan for controlling the routing modules, such as a manner for configuring the routing modules and/or a timing for configuring the routing module 210 to properly direct/route the item to the selected destination outbound station. The plan may be implemented to route the item for handling at the destination outbound station.

As illustrated in FIG. 2, outbound stations 230, 250, and 275 respectively correspond to different outbound activities (e.g., manners in which the items are to be handled). Outbound station 230 corresponds to a palletization outbound activity. For example, outbound station 230 comprises a single robotic arm 240 that picks items from conveyance structure 220 and places/palletizes the items on pallet 235. Outbound station 230 may further comprise a forklift 245 or other pallet moving system to load pallet 235 to a truck or container. In contrast, outbound stations 250, 275 correspond to a tuck/container loading outbound activity. For example, outbound station 250 comprises robot 260 and human worker 255 to load to truck 265 items being delivered on conveyance structure 225. As another example, outbound station 275 comprises a pair of robots 280, 285 to load to truck 290 items being delivered via conveyance structure 222. In some embodiments, control computer 295 is configured to route items across outbound stations 230, 250, 275 based at least in part on the outbound activities. For example, specific items, types of items, or end destination of items may be assigned to a particular outbound activity.

As further illustrated in FIG. 2, outbound stations 230, 250, and 275 respectively correspond to different modalities (e.g., the outbound stations have different handling modalities or capabilities). The modality for outbound station 230 comprises robotic arm 240 (e.g., to palletize items to pallet 235) and forklift 245 or other pallet moving system. The modality for outbound station 250 comprises human worker 255 and robot 260. Accordingly, outbound stations 250 may be more ideal for awkward items (e.g., awkwardly shaped items, fragile or deformable items, etc.) because a human worker may be more optimal for handling such items compared to robot workers. The modality for outbound station 275 comprises a plurality of robots 280, 285. Outbound station 275 may be ideal for heavy items, because robots 280, 285 may be operated to cooperatively lift a single heavy item, etc. Outbound station 275 may also be ideal for small/light and regularly shaped items (e.g., small boxes, etc.) because robot workers may be more optimal to perform repetitive tasks, etc.

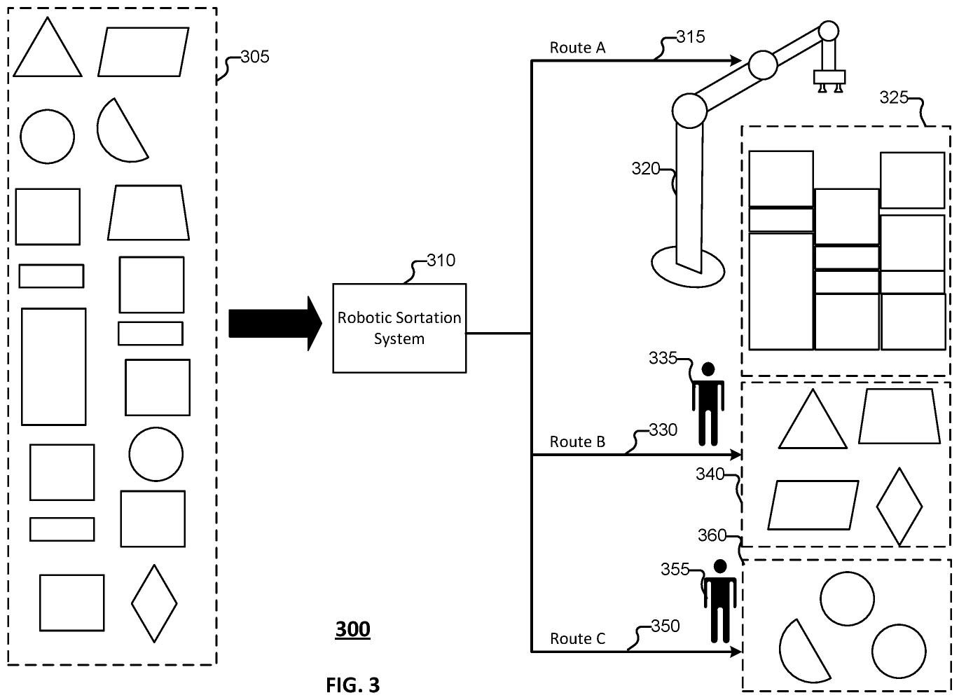

FIG. 3 is a diagram illustrating a system for routing a plurality of items across a plurality of outbound stations according to various embodiments. In the example shown, robotic sortation system 310 dynamically routes/sorts items based on shapes. An inflow of a set of items 305 is provided to system 300. In some cases, the set of items comprised in the inflow of items is known to robotic sortation system 310 in advance (e.g., the system stores a manifest or order associated with the stacking/loading of items). In other cases, the system has prior knowledge of the next N items to be delivered to the sortation zone, where N is an integer. The N items may be detected by a sensor system comprised at the input zone to which the inflow of items is input. Set of item 305 may comprise various items of different sizes, weights, types (e.g., box, envelope, polybag, etc.), route, content (e.g., Nike® shoes), etc.

In response to determining the set of items 305 to be routed/sorted across the plurality of outbound stations (e.g., along route 315 to outbound station 325, along route 330 to outbound station 340, and/or along route 350 to outbound station 360), robotic sortation system 310 dynamically determines the routing/sorting of the set of items 305. In the example shown, robotic sortation system 310 sorts the set of items 305 based at least in part on the item shapes. In some embodiments, robotic sortation system 310 controls to route robot-friendly items to outbound station 325. The robot-friendly items may be identified based on historical information to prior handlings/placements of items by robots or a particular type of robot. As an example, robot-friendly items may be identified as items for which a robot has a historical placement success rate greater than a minimum placement success threshold. As another example, robot-friendly items may be identified as items for which a robot has a historical average placement time less than a maximum placement time threshold.

As illustrated, robotic sortation system 310 routes rectangular items to outbound station 325 via route 315). Outbound station 325 may comprise robot 320 that is controlled to pick and place items, such as to load the items to a truck or other container. Robot 320 may be controlled by a control system to stack/load the items according to a predefined value function to optimize for one or more of stacking/loading speed, space utilization, stability, etc. In some embodiments, the control system attempts to find a solution for stacking/loading the items to satisfy minimum thresholds/constraints for one or more of the foregoing dimensions along which the handling of items may be optimized. For example, the control system finds a solution in which the stack or loading of items satisfies at least a minimum stability threshold.

Robotic sortation system 310 routes triangles and parallelograms to outbound station 340 via route 330. Outbound station 340 comprises human worker 335. Human workers may be deemed better suited to handle (e.g., pick, stack or load) irregular shaped items such as the triangles or parallelograms.

Robotic sortation system 310 routes round object such as half-moons, cylinders, etc. (e.g., carpets, posters, etc.) to outbound station 360 via route 350. Outbound station 360 comprises human worker 355. Human workers may be deemed better suited to handle (e.g., pick, stack or load) irregular shaped items such as the triangles or parallelograms. In some embodiments, the system stores a mapping of human work capabilities for each human worker. Different human workers may have different capabilities, such as maximum weight thresholds, maximum size thresholds, etc. The system may determine the human work capabilities for a particular human worker based on historical information such as placement success rates of particular items or types of items, number of broken items or item falls based on the human worker's handling/placement, etc.

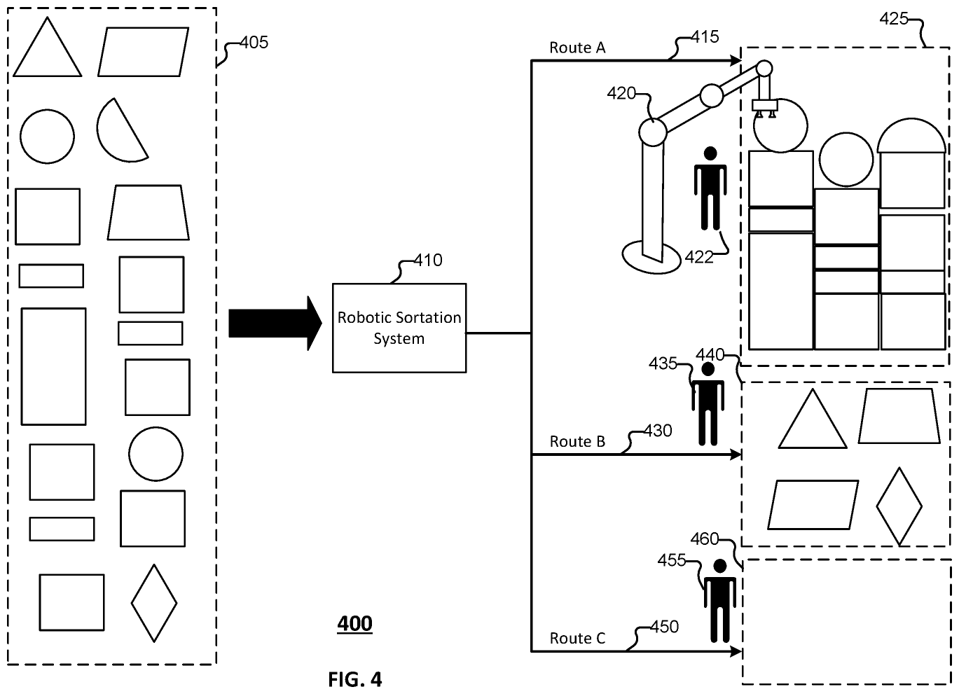

FIG. 4 is a diagram illustrating a system for routing a plurality of items across a plurality of outbound stations according to various embodiments. In the example shown, robotic sortation system 410 dynamically allocates items across outbound stations and routes/sorts items to the outbound stations based on shapes and handling modalities. An inflow of a set of items 405 is provided to system 400. In some cases, the set of items comprised in the inflow of items is known to robotic sortation system 410 in advance (e.g., the system stores a manifest or order associated with the stacking/loading of items). In other cases, the system has prior knowledge of the next N items to be delivered to the sortation zone, where N is an integer. The N items may be detected by a sensor system comprised at the input zone to which the inflow of items is input, or a sensor system upstream of the routing/sortation system or routing module used to sort/route the items. Set of item 405 may comprise various items of different sizes, weights, types (e.g., box, envelope, polybag, etc.), route, content (e.g., Nike® shoes), etc.

In response to determining the set of items 405 to be routed/sorted across the plurality of outbound stations (e.g., along route 415 to outbound station 425, along route 430 to outbound station 440, and/or along route 450 to outbound station 460), robotic sortation system 410 dynamically determines the routing/sorting of the set of items 405. In the example shown, robotic sortation system 410 sorts the set of items 405 based at least in part on the modalities/capabilities available at the outbound station.

In some embodiments, robotic sortation system 410 controls to route robot-friendly items to outbound station 425. Robotic sortation system 410 may further route items based on the capability of human worker 422. In the example shown, robot 420 and human worker 422 may place the rectangular boxes. The rectangular boxes may be placed toward the bottom of the stack/loading to satisfy a stability criteria (e.g., an expected stability being greater than a minimum stability threshold) or a space utilization criteria. In contrast to system 300 of FIG. 3, outbound station 425 comprises both a human worker and a robot. System 400 thus utilizes robot and human loading and/or stacking. In the example shown, human worker 422 may place the rounded items (e.g., spheres, cylinders, half-moons, etc.) on top of the stack of rectangular boxes. The rounded items may be difficult for robot 420 to grasp and/or place at the height of the top rectangular box. However, human worker 422 may be well-suited to place the rounded items on top of the stack of rectangular boxes to improve the space utilization of the truck or other container.

As illustrated, robotic sortation system 310 routes rectangular items to outbound station 325 via route 315). Outbound station 325 may comprise robot 320 that is controlled to pick and place items, such as to load the items to a truck or other container. Robot 320 may be controlled by a control system to stack/load the items according to a predefined value function to optimize for one or more of stacking/loading speed, space utilization, stability, etc. In some embodiments, the control system attempts to find a solution for stacking/loading the items to satisfy minimum thresholds/constraints for one or more of the foregoing dimensions along which the handling of items may be optimized. For example, the control system finds a solution in which the stack or loading of items satisfies at least a minimum stability threshold.

Robotic sortation system 410 routes triangles and parallelograms to outbound station 440 via route 430. Outbound station 440 comprises human worker 435. Human workers may be deemed better suited to handle (e.g., pick, stack or load) irregular shaped items such as the triangles or parallelograms.

In the example shown, robotic sortation system 410 does not route any items to outbound station 460 via route 450 for handling by human worker 455. As an example, robotic sortation system 410 may determine not to route any items to outbound station 460 because set of items 405 may be associated with a particular order or end destination and such order or end destination may not be assigned to outbound station 460. The order or end destination may be assigned to outbound stations 425 and 440. As another example, robotic sortation system 410 may determine not to route any items to outbound station 460 based on the value function used to determine a plan for routing/delivering items and/or stacking/loading items at the outbound stations. The value function may determine to only route items to outbound stations 425 and 440 because of a constraint associated with space utilization (e.g., to minimize the number of trucks or containers needed to comprise the set of items).

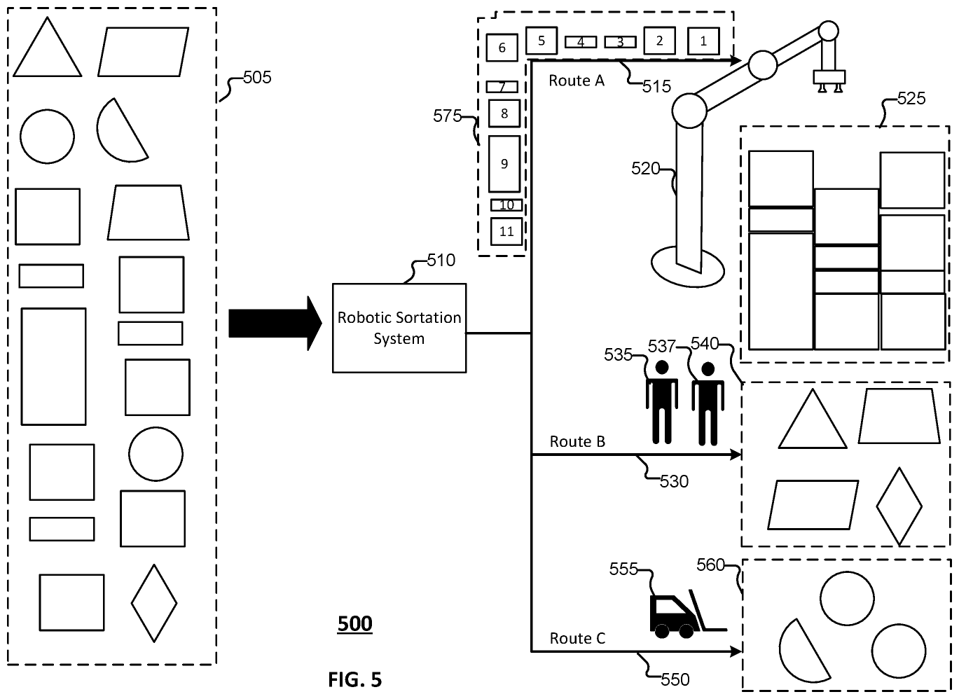

FIG. 5 is a diagram illustrating a system for routing a plurality of items across a plurality of outbound stations according to various embodiments. In the example shown, robotic sortation system 510 dynamically routes/sorts items based on optimal stacking (e.g., according to a predefined value function). An inflow of a set of items 505 is provided to system 500. In some cases, the set of items comprised in the inflow of items is known to robotic sortation system 510 in advance (e.g., the system stores a manifest or order associated with the stacking/loading of items). In other cases, the system has prior knowledge of the next N items to be delivered to the sortation zone, where N is an integer. The N items may be detected by a sensor system comprised at the input zone to which the inflow of items is input. Set of item 505 may comprise various items of different sizes, weights, types (e.g., box, envelope, polybag, etc.), route, content (e.g., Nike® shoes), etc.

In response to determining the set of items 505 to be routed/sorted across the plurality of outbound stations (e.g., along route 515 to outbound station 525, along route 530 to outbound station 540, and/or along route 550 to outbound station 560), robotic sortation system 510 dynamically determines the routing/sorting of the set of items 505. In the example shown, robotic sortation system 510 sorts the set of items 505 based at least in part on the item shapes. In some embodiments, robotic sortation system 510 controls to route robot-friendly items to outbound station 525. The robot-friendly items may be identified based on historical information to prior handlings/placements of items by robots or a particular type of robot. As an example, robot-friendly items may be identified as items for which a robot has a historical placement success rate greater than a minimum placement success threshold. As another example, robot-friendly items may be identified as items for which a robot has a historical average placement time less than a maximum placement time threshold.

As illustrated, robotic sortation system 510 routes rectangular items to outbound station 525 via route 515). Outbound station 525 may comprise robot 520 that is controlled to pick and place items, such as to load the items to a truck or other container. Robot 520 may be controlled by a control system to stack/load the items according to a predefined value function to optimize for one or more of stacking/loading speed, space utilization, stability, etc. In some embodiments, the control system attempts to find a solution for stacking/loading the items to satisfy minimum thresholds/constraints for one or more of the foregoing dimensions along which the handling of items may be optimized. For example, the control system finds a solution in which the stack or loading of items satisfies at least a minimum stability threshold.

Robotic sortation system 510 routes triangles and parallelograms to outbound station 540 via route 530. Outbound station 540 comprises human workers 535, 537. Human workers may be deemed better suited to handle (e.g., pick, stack or load) irregular shaped items such as the triangles or parallelograms. Human workers may be deemed better suited to handle (e.g., pick, stack or load) irregular shaped items such as the triangles or parallelograms. In some embodiments, the system stores a mapping of human work capabilities for each human worker. Different human workers may have different capabilities, such as maximum weight thresholds, maximum size thresholds, etc. The system may determine the human work capabilities for a particular human worker based on historical information such as placement success rates of particular items or types of items, number of broken items or item falls based on the human worker's handling/placement, etc.

Robotic sortation system 510 routes round object such as half-moons, cylinders, etc. (e.g., carpets, posters, etc.) to outbound station 560 via route 550. Outbound station 560 comprises forklift 555. Forklift 555 may be deemed ideal to handle cylinders such as large carpets, etc.

In some embodiments, robotic sortation system 510 determines an order of subset of items 575 to be delivered to outbound station 525. For example, the order is denoted by the numbering associated with the various items in subset of items 575. Robotic sortation system 510 may determine the ordering of the items to be delivered based at least in part on a value function. The value function may determine an order that optimizes along a dimension (e.g., speed, stability, weight balancing, space utilization etc.) while balancing various other constraints. For example, the value function may be configured to optimize stability subject to various other constraints such as a total available space, worker capability, weight balancing, a maximum speed, etc. In some embodiments, the value obtained from the value function may be based on a set of variously weighted factors. For example, the value function may have different weights for stability, speed/time for completion, weight balancing, etc.

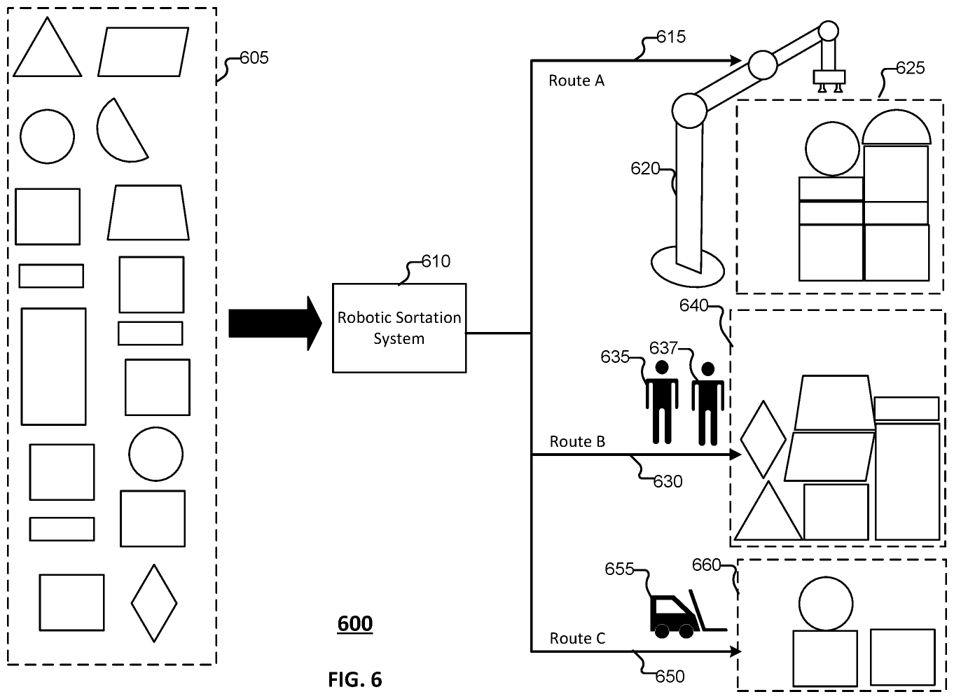

FIG. 6 is a diagram illustrating a system for routing a plurality of items across a plurality of outbound stations according to various embodiments. In the example shown, robotic sortation system 610 dynamically routes/sorts items with a dynamic feed rate based on one or more of item characteristics and outbound station/work capabilities. An inflow of a set of items 605 is provided to system 600. In some cases, the set of items comprised in the inflow of items is known to robotic sortation system 610 in advance (e.g., the system stores a manifest or order associated with the stacking/loading of items). In other cases, the system has prior knowledge of the next N items to be delivered to the sortation zone, where N is an integer. The N items may be detected by a sensor system comprised at the input zone to which the inflow of items is input. Set of item 605 may comprise various items of different sizes, weights, types (e.g., box, envelope, polybag, etc.), route, content (e.g., Nike® shoes), etc.

In some embodiments, system 600 routes the set of items 605 according to a dynamic feed rate based on one or more predefined criteria. For example, system 600 routes items according to a primary criteria such as a feed rate, and according to a secondary criteria such as load balancing. Different types of workers have different capabilities such as speed at which the workers can handle items or particular items/types of items. System 600 routes the items to optimize based at least in part on feed rate to maximize the speed at which the outbound stations can handle set of items 605. However, a worker(s) at an outbound station may be over burdened and operate slower than expected causing a backlog of items being routed to the outbound station. Accordingly, system 600 (e.g., robotic sortation system 610) may throttle the routing of items to that particular outbound station. System 600 may determine the routing of items across the plurality of outbound stations to load balance the various sets of workers at the corresponding outbound stations.

In response to determining the set of items 605 to be routed/sorted across the plurality of outbound stations (e.g., along route 615 to outbound station 625, along route 630 to outbound station 640, and/or along route 650 to outbound station 660), robotic sortation system 610 dynamically determines the routing/sorting of the set of items 605. In the example shown, robotic sortation system 610 sorts the set of items 605 based at least in part on a predetermined value function. The value function may be configured to bias/optimize for maximizing speed while load balancing workers at the various output stations.

Robotic sortation system 610 load balances the workload across outbound stations 625, 640, and 660. For example, robot 602 at outbound station 625 may be ideal for smaller items, human workers 635, 637 at outbound station 640 may be ideal for irregularly-shaped items or otherwise irregular items (e.g., fragile items, deformable items, etc.), and forklift 655 at outbound station 660 may be deemed ideal for loading large items (e.g., carpets, large boxes, pallets, etc.).

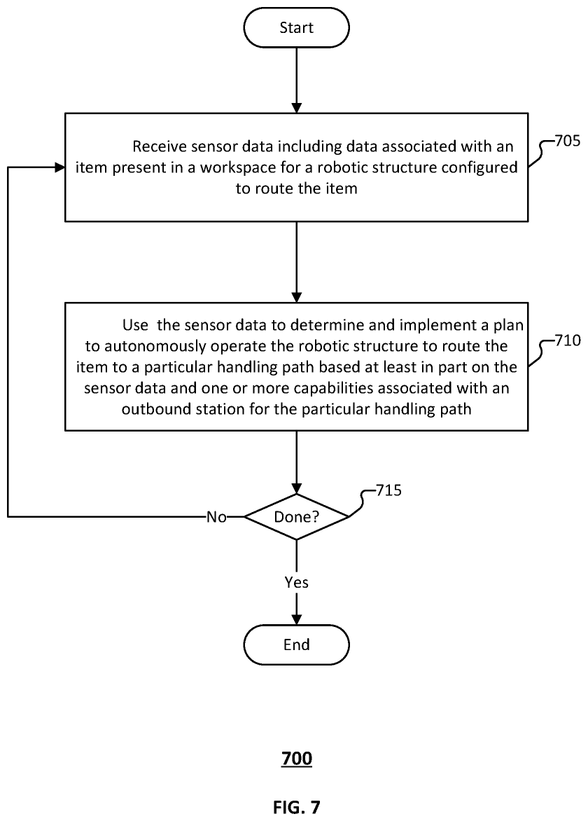

FIG. 7 illustrates a method for routing an item to an outbound station according to according to various embodiments. In some embodiments, process 700 is implemented at least in part by system 100 and/or system 200.

At 705, the system receives sensor data including data associated with an item present in a workspace for a robotic structure configured to route the item. At 710, the system uses the sensor data to determine and implement a plan to autonomously operate the robotic structure to route the item to a particular handling path based at least in part on the sensor data and one or more capabilities associated with an outbound station for the particular handling path. At 715, a determination is made as to whether process 700 is complete. In some embodiments, process 700 is determined to be complete in response to a determination that no further items are to be routed, a loading of a manifest or freight carrier is complete, no further plans for touting items are to be determined, an administrator indicates that process 700 is to be paused or stopped, etc. In response to a determination that process 700 is complete, process 700 ends. In response to a determination that process 700 is not complete, process 700 returns to 705.

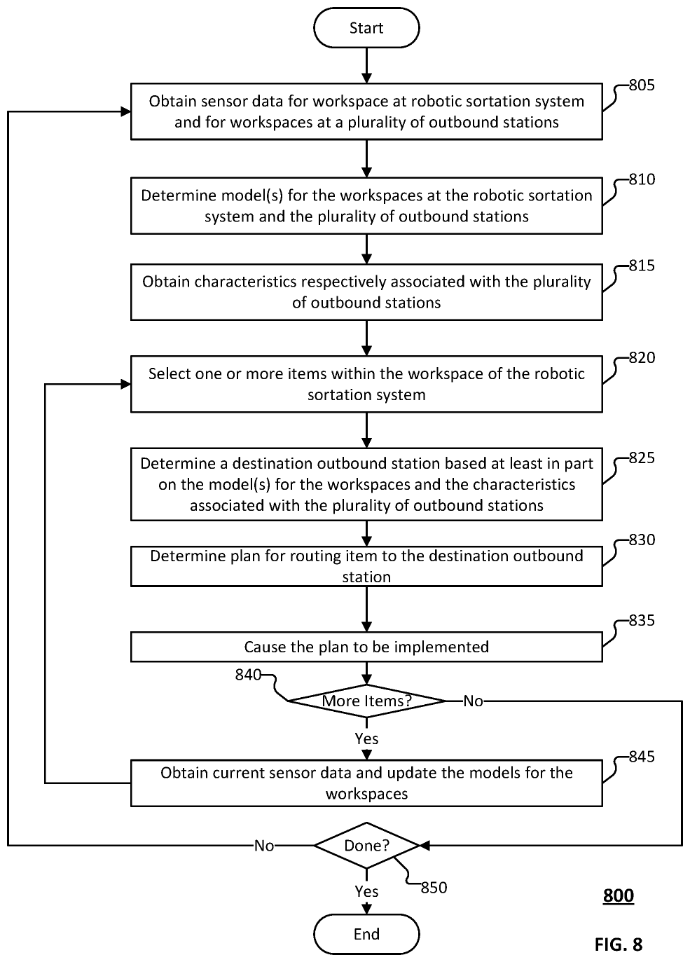

FIG. 8 illustrates a method for routing a plurality of items across a plurality of outbound stations according to according to various embodiments. In some embodiments, process 800 is implemented at least in part by system 100 and/or system 200.

At 805, the system obtains sensor data for a workspace at a robotic sortation system and for workspaces at a plurality of outbound stations.

At 810, the system determines one or more models of the workspaces at the robotic sortation system and the plurality of outbound stations. In some embodiments, the system generates the one or more models for the workspaces based at least in part on the sensor data. The sensor data may include data obtained by a vision system with which the system can segment and identify objects in the workspaces, such as items within the workspaces. Items may be identified based on one or more item characteristics such as an item identifier, an item label, an item size, an item shape, a serial number, etc. In connection with generating the one or more models, the system can determine a state in the various workspaces, such as a state of an outbound station (e.g., a stack/loading of items, a state of a robot, etc.).

At 815, the system obtains characteristics respectively associated with the plurality of outbound stations. The characteristics for an outbound station may include worker capabilities (e.g., a speed at which the robot can move, a weight that the robot can lift, etc.), an identification or worker types for one or more workers in the workspace, a worker state (e.g., a hardware failure, an average throughput).

At 820, the system selects one or more items within the workspace of the robotic sortation system.

At 825, the system determines a destination outbound station based at least in part on the model(s) for the workspaces and the characteristics associated with the plurality of outbound stations.

At 830, the system determines a plan for routing the item to the destination outbound station. The plan may include selection of a destination outbound station for a particular item, a timing for delivery of the item, one or more modules to be controlled to properly route the item and/or to deliver the item according to the expected time (e.g., to control motors or actuators that cause conveyors to move the item to a particular outbound station or an actuator to divert the item along a particular path corresponding to the destination outbound station, etc.).

At 835, the system causes the plan to be implemented. The system may control robot workers or send a plan to a worker (e.g., send the plan to a control system for a robot worker, display the plan to a human worker, etc.).

At 840, the system determines whether another item(s) is to be routed. In response to determining that another item(s) is to be routed, process 800 proceeds to 835. Conversely, in response to determining that no further items are to be routed, process 800 proceeds to 850.

At 845, the system obtains current sensor data and updates the model(s) for the workspaces. Thereafter, process 800 returns to 820 and process 800 iterates over 820-840 until no further items are to be routed.

At 850, a determination is made as to whether process 800 is complete. In some embodiments, process 800 is determined to be complete in response to a determination that no further items are to be routed, a loading of a manifest or freight carrier is complete, no further plans for touting items are to be determined, an administrator indicates that process 800 is to be paused or stopped, etc. In response to a determination that process 800 is complete, process 800 ends. In response to a determination that process 800 is not complete, process 800 returns to 805.

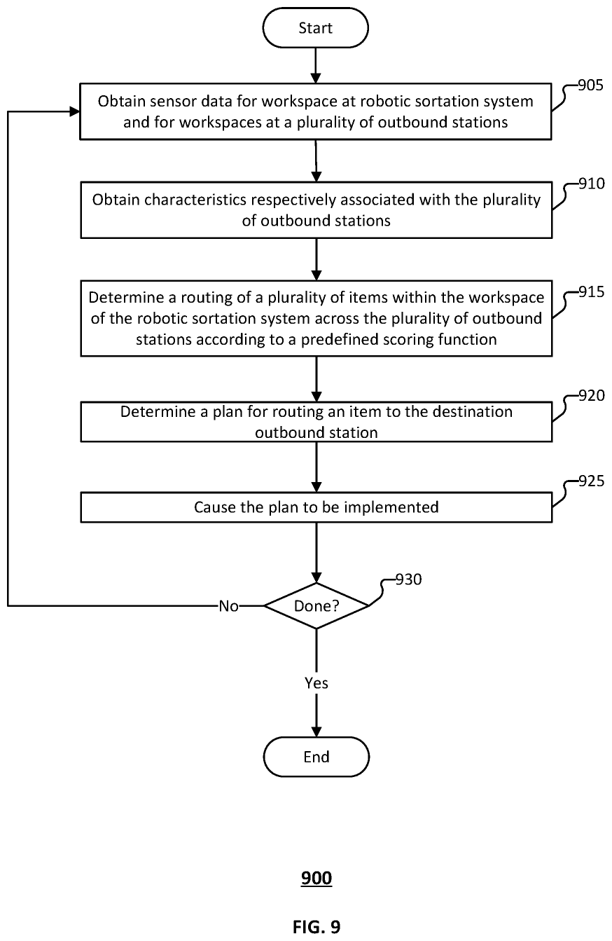

FIG. 9 illustrates a method for routing a plurality of items across a plurality of outbound stations according to according to various embodiments. In some embodiments, process 900 is implemented at least in part by system 100 and/or system 200. Process 900 may be invoked by process 800, such as by 830.

At 905, the system obtains sensor data for workspace at a robotic sortation system and for workspaces at a plurality of outbound stations. At 910 the system obtains characteristics respectively associated with the plurality of outbound stations. At 915, the system determines a routing of a plurality of items within the workspace of the robotic sortation system across the plurality of outbound stations according to a predefined value function. At 920, the system determines a plan for routing an item to the destination outbound station. At 925, the system causes the plan to be implemented. Causing the plan to be implemented may include providing the plan to the system, device, or other process that invoked process 900. At 930, a determination is made as to whether process 900 is complete. In some embodiments, process 900 is determined to be complete in response to a determination that no further items are to be routed, a loading of a manifest or freight carrier is complete, no further plans for touting items are to be determined, an administrator indicates that process 900 is to be paused or stopped, etc. In response to a determination that process 900 is complete, process 900 ends. In response to a determination that process 900 is not complete, process 900 returns to 905.

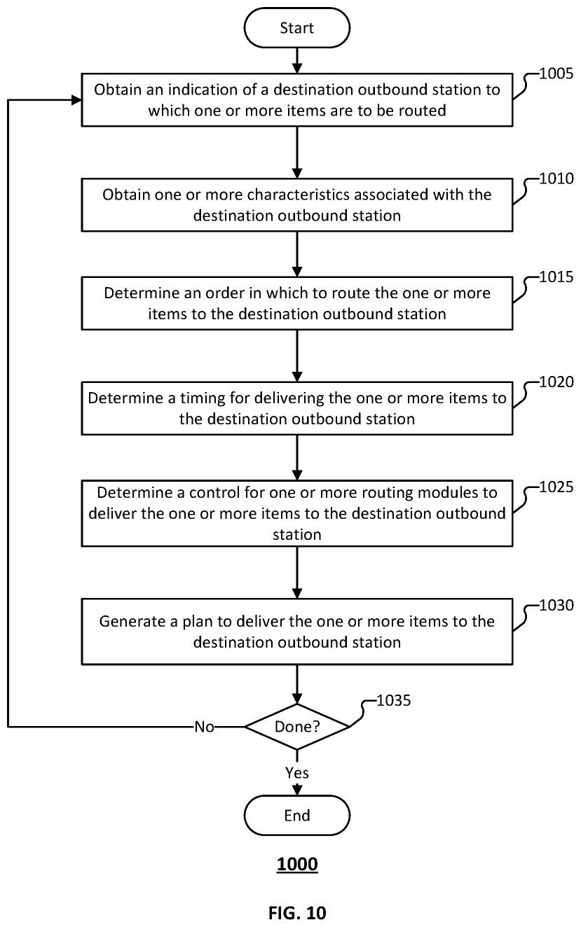

FIG. 10 illustrates a method for obtaining a plan for routing a plurality of items to one or more outbound stations according to according to various embodiments. In some embodiments, process 1000 is implemented at least in part by system 100 and/or system 200.

At 1005, the system obtains an indication of a destination outbound station to which one or more items are to be routed. At 1010, the system obtains one or more characteristics associated with the destination outbound station. At 1015, the system determines an order in which the one or more items are to be routed to the destination outbound station. At 1020, the system determines a timing for delivering the one or more items to the destination outbound station. At 1025, the system determines a control for one or more routing modules to deliver the one or more items to the destination outbound station. At 1030, the system generates a plan to deliver the one or more items to the destination outbound station. At 1035, a determination is made as to whether process 1000 is complete. In some embodiments, process 1000 is determined to be complete in response to a determination that no further items are to be routed, a loading of a manifest or freight carrier is complete, no further plans for touting items are to be determined, an administrator indicates that process 1000 is to be paused or stopped, etc. In response to a determination that process 1000 is complete, process 1000 ends. In response to a determination that process 1000 is not complete, process 1000 returns to 1005.

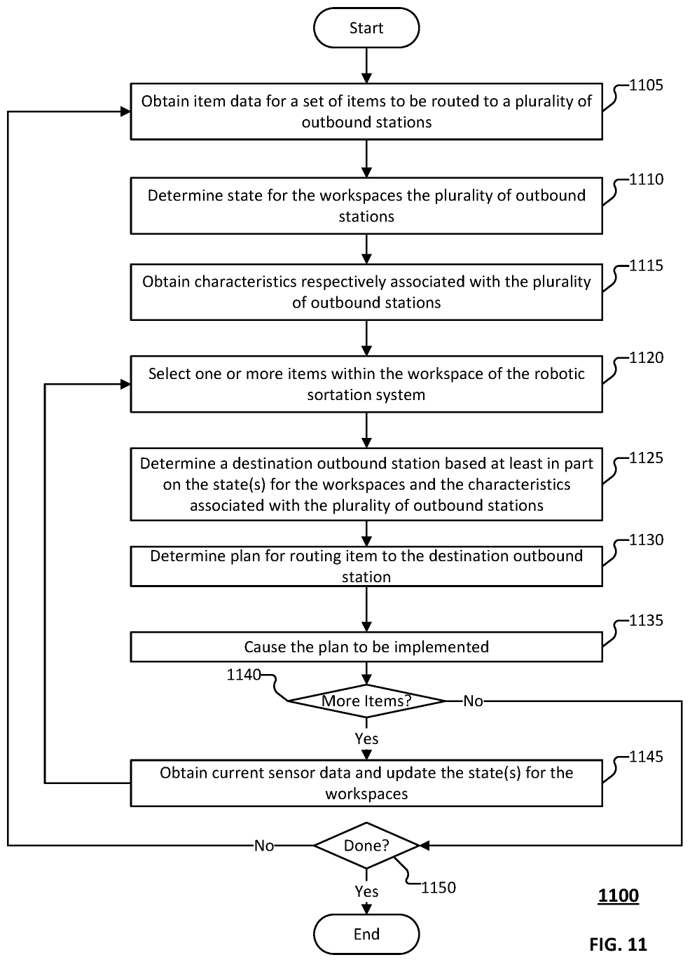

FIG. 11 illustrates a method for routing a plurality of items across a plurality of outbound stations according to according to various embodiments. In some embodiments, process 1100 is implemented at least in part by system 100 and/or system 200.

At 1105, the system obtains item data for a set of items to be routed to a plurality of outbound stations. The item data includes an indication of a set of items to be routed, such as a manifest or order of a set of items to be transported to a particular end destination, or an indication of the next M items to be delivered to the robotic routing system. The item data may further include one or more item characteristics, such as an item attribute (e.g., size, weight, identifier, type of item, type of packaging, etc.).

At 1110, the system determines one or more states of the workspaces at the plurality of outbound stations. In some embodiments, the system obtains state information based on sensor data captured by one or more sensor systems (e.g., vision systems) within the workspaces.

The system may generate a model(s) for the workspaces based at least in part on the state information. The sensor data may include data obtained by a vision system with which the system can segment and identify objects in the workspaces, such as items within the workspaces. Items may be identified based on one or more item characteristics such as an item identifier, an item label, an item size, an item shape, a serial number, etc. In connection with generating the one or more models, the system can determine a state in the various workspaces, such as a state of an outbound station (e.g., a stack/loading of items, a state of a robot, etc.).

The system can use the state information to determine a state of a worker(s) at a particular outbound station. For example, the system determines one or more of (i) whether the worker is active, (ii) a current throughput (e.g., a current average throughput over a predefined period of time), (iii) whether the worker has a hardware failure (e.g., a torn suction cup), and/or (iv) whether the worker is paused or waiting for assistance (e.g., if a robotic work requires human intervention to complete a task, etc.), etc.

At 1115, the system obtains characteristics respectively associated with the plurality of outbound stations. The characteristics for an outbound station may include worker capabilities (e.g., a speed at which the robot can move, a weight that the robot can lift, etc.), an identification or worker types for one or more workers in the workspace, a worker state (e.g., a hardware failure, an average throughput).

At 1120, the system selects one or more items within the workspace of the robotic sortation system. For example, the system selects one or more items to be routed to an outbound station.

At 1125, the system determines a destination outbound station based at least in part on the state(s) for the workspaces and the characteristics associated with the plurality of outbound stations. Certain items or types of items may be assigned to a subset of outbound stations, and the system determines how to route the items/types of items across the subset of outbound stations, such as based on optimizing a value function (e.g., optimizing one or more of speed to complete the loading, space utilization, weight balancing/distribution, expected stability, etc.). A value for routing an item to a particular outbound station based on the value function may be computed based at least in part on the state of the workspace for the outbound station,

At 1130, the system determines a plan for routing the item to the destination outbound station. The plan may include selection of a destination outbound station for a particular item, a timing for delivery of the item, one or more modules to be controlled to properly route the item and/or to deliver the item according to the expected time (e.g., to control motors or actuators that cause conveyors to move the item to a particular outbound station or an actuator to divert the item along a particular path corresponding to the destination outbound station, etc.).

At 1135, the system causes the plan to be implemented. The system may control robot workers or send the plan to a worker (e.g., send the plan to a control system for a robot worker, display the plan to a human worker, etc.).

At 1140, the system determines whether another item(s) is to be routed. In response to determining that another item(s) is to be routed, process 1100 proceeds to 1135. Conversely, in response to determining that no further items are to be routed, process 1100 proceeds to 1150.

At 1145, the system obtains current sensor data and updates the model(s) for the workspaces. Thereafter, process 1100 returns to 1120 and process 1100 iterates over 1120-1140 until no further items are to be routed.

At 1150, a determination is made as to whether process 1100 is complete. In some embodiments, process 1100 is determined to be complete in response to a determination that no further items are to be routed, a loading of a manifest or freight carrier is complete, no further plans for touting items are to be determined, an administrator indicates that process 1100 is to be paused or stopped, etc. In response to a determination that process 1100 is complete, process 1100 ends. In response to a determination that process 1100 is not complete, process 1100 returns to 1105.

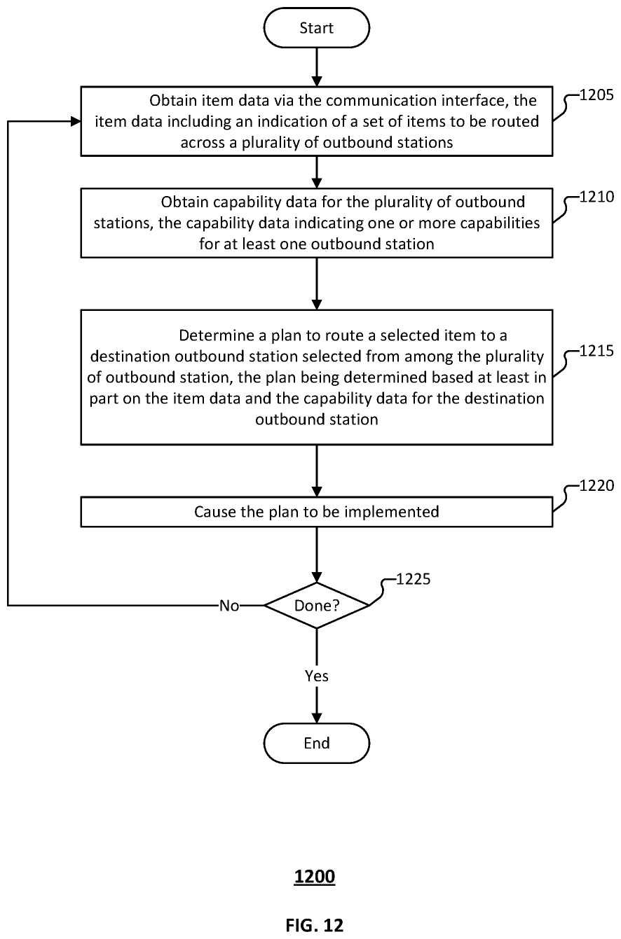

FIG. 12 illustrates a method for routing an item to an outbound station according to according to various embodiments. In some embodiments, process 1200 is implemented at least in part by system 100 and/or system 200.

At 1205, the system obtains item data via the communication interface, the item data including an indication of a set of items to be routed across a plurality of outbound stations. At 1210, the system obtains capability data for the plurality of outbound stations, the capability data indicating one or more capabilities for at least one outbound station. At 1215, the system determines a plan to route a selected item to a destination outbound station selected from among the plurality of outbound station, the plan being determined based at least in part on the item data and the capability data for the destination outbound station. At 1220, the system causes the plan to be implemented to route the selected item to a particular handling path associated with the destination outbound station. At 1225, a determination is made as to whether process 1200 is complete. In some embodiments, process 1200 is determined to be complete in response to a determination that no further items are to be routed, a loading of a manifest or freight carrier is complete, no further plans for touting items are to be determined, an administrator indicates that process 1200 is to be paused or stopped, etc. In response to a determination that process 1200 is complete, process 1200 ends. In response to a determination that process 1200 is not complete, process 1200 returns to 1205.

Various examples of embodiments described herein are described in connection with flow diagrams. Although the examples may include certain steps performed in a particular order, according to various embodiments, various steps may be performed in various orders and/or various steps may be combined into a single step or in parallel.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a communication interface; and
one or more processors coupled to the communication interface and configured to:
obtain item data via the communication interface, the item data including an indication of a set of items to be routed across a plurality of outbound stations;
obtain capability data for the plurality of outbound stations, the capability data indicating one or more capabilities or state for at least one outbound station;
determine a plan to route a selected item to a destination outbound station selected from among the plurality of outbound station, the plan being determined based at least in part on the item data and the capability data for the destination outbound station; and
cause the plan to be implemented to route the selected item to a particular handling path associated with the destination outbound station.

2. The system of claim 1, wherein the item data comprises an item attribute associated with is the selected item.

3. The system of claim 2, wherein the item attribute includes one or more of: (a) a weight, (b) a size, (c) a destination, (d) an order with which the item is associated, (e) a packaging type, and (f) an item category.

4. The system of claim 1, further comprising:
a sensor system configured to collect sensor data in a workspace for a robotic structure configured to route the item; and
the item data is obtained based at least in part on the sensor data.

5. The system of claim 4, wherein the sensor data comprises information pertaining to a plurality of other items or objects in the workspace.

6. The system of claim 4, wherein the sensor data comprises information pertaining to a state of the destination outbound station.

7. The system of claim 6, wherein the information pertaining to the state of the destination outbound station includes information pertaining to one or more items comprised in an outbound workspace of the outbound station.

8. The system of claim 7, wherein the information pertaining to the state of the outbound station includes a queue of items to be handled by the outbound station.

9. The system of claim 6, wherein the item is routed based at least in part on the state of the destination outbound station.

10. The system of claim 1, wherein the one or more capabilities includes one or more of: (i) a number of robots at a particular outbound station, (ii) a set of human operators handling items at the particular outbound station, (iii) a robot truck floor-loader, (iv) a palletizer, (v) a throughput, (vi) a buffer area to store a queue of items, (vii) a derating of a robot at the particular outbound station, (viii) a weight limit for handling items at the particular outbound station, and (ix) an availability of space in a freight carrier at the particular outbound station.

11. The system of claim 1, wherein the item data comprises a manifest assigned to one or is more of the plurality of outbound stations, and the item is routed to the destination outbound station based at least in part on the manifest assigned to the destination outbound station.

12. The system of claim 1, wherein the one or more processors are further configured to:
identify a plurality of items in the workspace for a robotic structure configured to route items along the particular handling path;
determine a set of plans to route the plurality of items across a plurality of outbound stations; and
cause the robotic structure to implement the set of plans to route the plurality of items.

13. The system of claim 12, wherein determining the set of plans to route the plurality of items includes for each item:
selecting the destination outbound station from the plurality of outbound stations; and
causing the robotic structure to route the particular item to the destination outbound station.

14. The system of claim 1, wherein causing the plan to be implemented to route the selected item to the destination outbound station includes determining a timing for routing and delivery of the selected item to the destination outbound station.

15. The system of claim 1, wherein the plan is determined based at least in part on a determination of a routing that maximizes aggregate throughput of the set of items across the plurality of outbound stations.

16. The system of claim 15, wherein maximizing the aggregate throughput of the set of items is subject to a set of predefined constraints.

17. The system of claim 1, wherein the one or more processors are further configured to control a delivery order of a subset of the set of items to the destination outbound station, and cause the subset of items to be routed and delivered according to the delivery order.

18. The system of claim 1, wherein the one or more processors are further configured to control a delivery speed of the set of items of items in connection with causing the plan to be implemented to route the selected item to the particular handling path.

19. The system of claim 11, wherein at least a subset of the set of items are routed substantially in parallel.

20. The system of claim 1, wherein the plan to route the item is determined based at least in part on a stability of a stack of items at the destination outbound station.

21. A method, comprising:
obtaining item data via the communication interface, the item data including an indication of one or more items to be routed across a plurality of outbound stations;
obtaining capability data for the plurality of outbound stations, the capability data indicating one or more capabilities or state for at least one outbound station;
determining a plan to route a selected item to a destination outbound station selected from among the plurality of outbound station, the plan being determined based at least in part on the item data and the capability data for the destination outbound station; and
causing the plan to be implemented to route the item to a particular handling path associated with the destination outbound station.

22. A computer program product embodied in a non-transitory computer readable medium, comprising computer instructions for:
obtaining item data via the communication interface, the item data including an indication of one or more items to be routed across a plurality of outbound stations;
obtaining capability data for the plurality of outbound stations, the capability data indicating one or more capabilities or state for at least one outbound station;
determining a plan to route a selected item to a destination outbound station selected from among the plurality of outbound station, the plan being determined based at least in part on the item data and the capability data for the destination outbound station; and
causing the plan to be implemented to route the item to a particular handling path associated with the destination outbound station.
